(19) United States
(12) Patent Application Publication
(10) Pub. No.: US 2001/0047387 A1
(43) Pub. Date: Nov. 29, 2001

(54) Systems and methods for providing distributed cross-enterprise portals

(75) Inventor: Russell A. Brockhurst, Austin, TX (US)

Correspondence Address: Kevin R. Imes, Baker Botts L.L.P., Suite 600, 2001 Ross Avenue, Dallas, TX, 75201, US

(73) Assignee: Exoplex, Inc.

(21) Appl. No.: 09/811,209

(22) Filed: Mar. 16, 2001

Related U.S. Application Data
(60) Provisional application No. 60/192,729, filed on Mar. 27, 2000.
(60) Provisional application No. 60/213,384, filed on Jun. 23, 2000.

(51) Int. Cl. G06F 15/16; G06F 9/44

(52) U.S. Cl. 709/203; 709/315

(57) ABSTRACT

A system and method for providing distributed cross-enterprise portals is disclosed. In one form, a distributed portal to portal system includes at least one supplier portal operable to provide communication between a plurality of networks and at least one encapsulated component operably associated with the at least one supplier portal. The system further includes at least one user portal operable to receive a plurality of distributed encapsulated components. The encapsulated components may further include a global identifier operable to globally identify the distributed component.

### CROSS REFERENCE TO RELATED APPLICATIONS

This application claims priority from U.S. Provisional Patent Application Ser. No. 60/192,729, filed Mar. 27, 2000, and entitled “SYSTEM AND METHOD FOR PROVIDING DISTRIBUTED CROSS-ENTERPRISE PORTALS” and U.S. Provisional Patent Application Ser. No. 60/213,384, filed Jun. 23, 2000, and entitled “SYSTEM AND METHOD FOR PROVIDING DISTRIBUTED CROSS-ENTERPRISE PORTALS.”

### TECHNICAL FIELD

The present invention generally relates to network systems, and more particularly, towards a system and method for providing distributed cross-enterprise portals.

### BACKGROUND OF THE INVENTION

There are a number of different companies that are trying to build portals for the transfer of specific types of information to support activities such as customer relationship management (http://www.vignette.com), supply chain management (http://www.i2.com, http://www.aspect.com), document exchange (http://www.ecertain.com) and project collaboration (http://www.inovie.com/products.html, http://www.eroom.com, http://www.agilesoft.com). These services offer detailed solutions for specific business processes. Most also implement server-centric business models in which all data is funneled through a central server.

Another group of companies are developing component-based portals (http://www.radnet.com, http://www.iplanet.com, and http://www.appsolut.com). These vendors provide Application Programming Interfaces (API's) and other development tools so that custom components can be integrated into their standard product. The iplanet e-commerce Portal Platform (released Feb. 22, 2000) is the only product promoted to allow companies to “ . . . unify their internal portal projects and plug in value-added applications and services from other leading portal and e-commerce vendors . . . ”. Components developed by the “ . . . leading portal and e-commerce vendors . . . ” have limited distribution capabilities.

Other companies are developing corporate portals that support cross-enterprise transactions (http://www.datachannel.com, http://www.spaceworks.com, http://www.webmethods.com, http://www.worldweb.net, http://www.bea.com). These portals work by passing transactions (such as XML/XSL documents) between corporate portals and by integrating these transactions into each companies backend systems. These corporate portals are able to exchange data with other systems.

A third category of products supports the distribution of applications and content including (http://www.marimba.com, and http://www.backweb.com) (known as “push” based technologies). Of these vendors, Marimba seems to be the most advanced with a product called “Timbale” that “ . . . provides a streamlined method to replicate and synchronize applications and content across multiple servers and data centers.” These products do provide a generic method for the distribution of applications and content.

Since a publisher using a “push” technology must have prior knowledge of the target-operating environment, push technologies are best suited for use by a single company to manage the distribution of specific types of information, or for the general distribution of information with minimal operating systems dependencies.

### SUMMARY OF THE INVENTION

In accordance with teachings of the present invention, systems and methods are described for providing distributed cross-enterprise portals. According to one aspect of the present invention a cross-enterprise system includes a distributed component stored within a storage medium associated with a first portal, and a second portal operable to receive the distributed component. The component is preferably operable to provide a cross-enterprise environment associated with the first and second portals.

According to another aspect of the present invention a method for providing a portal to portal environment is provided. The method includes providing a component associated with a supplier portal and distributing the component to a user portal. The component is preferably operable to provide an association between the supplier portal and the user portal.

According to a further aspect of the present invention a distributed portal to portal system is provided. The system includes at least one supplier portal operable to provide communication between a plurality of networks and at least one encapsulated component operably associated with the at least one supplier portal. The system further includes at least one user portal operable to receive a plurality of distributed encapsulated components including a global identifier operable to globally identify the distributed component.

According to another aspect of the present invention a secure network system is provided. The system includes an unbounded network operable to serve a plurality of servers and end users and a bounded network comprised within the unbounded network. The bounded network is operable to serve a limited number of servers and end users. The system further includes a plurality of distributed access points operable to divert network traffic associated with the servers within the bounded network from the unbounded network. In one embodiment, each access point may be operable to intercept network traffic originating from a distinct group of workstations.

According to a further aspect of the present invention, a secure network includes the implementation of a bounded network (serving a limited number of servers and end users) within an unbounded network (serving an unlimited number of servers and end users). The network traffic associated with the servers within the bounded network is diverted from the unbounded network at a plurality of distributed access points where each access point intercepts the network traffic originating from a distinct group of workstations (end users). The system further includes access points that use filters to limit network traffic on the bounded network to properly formatted and otherwise legitimate traffic and use limitors to balance the traffic associated with specific web sites.

According to another aspect of the present invention, a cross-enterprise system for retail environments is provided. The system includes at least one component stored within a storage medium and a plurality of distributed components operably associated with a cross-enterprise portal. The cross-enterprise portal is used in association with the retail environment.

According to a further aspect of the present invention, a method for providing a retail mall using a distributed components is provided. The method includes providing at least one component operably associated with a mall and associating a distributed component with the component. The method further includes providing the distributed component operable to be used in association with a user accessing the retail mall.

It is a technical advantage of the present invention to propagate components through supply chains.

It is a further technical advantage of the present invention to distribute components to end users.

It is another technical advantage of the present invention to provide a method for managing or distributing portal components.

It is an additional technical advantage of the present invention that applications or content distributed from different sources will be able to coexist within various operating environments.

It is a further technical advantage of the present invention to encapsulate or protect applications and content that is distributed.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an illustration of a system for providing a cross enterprise portal according to one embodiment of the present invention;

FIG. 2 is an illustration of a cross-enterprise portal according to one embodiment of the present invention;

FIG. 3 is an illustration of a system for distributing components among suppliers and users according to one embodiment of the present invention;

FIG. 4 illustrates interaction between external interfaces of components of a cross-enterprise portal according to one embodiment of the present invention;

FIG. 5 illustrates a system having distributed access locations according to one embodiment of the present invention; and

FIG. 6 illustrates an exemplary retail mall deploying cross-enterprise portal components according to one embodiment of the present invention.

### DETAILED DESCRIPTION OF THE INVENTION

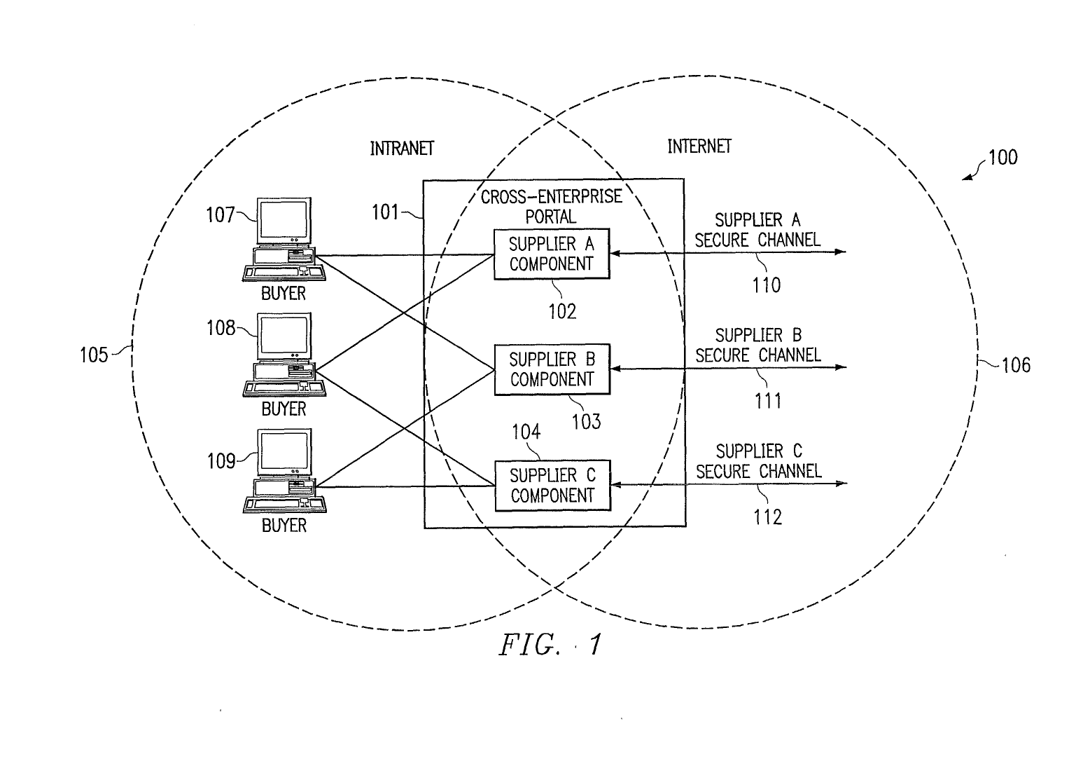

Preferred embodiments of the present invention and their advantages are best understood by reference to FIGS. 1 through 6, wherein like numbers are used to indicate like and corresponding parts. The conceptual ground work for the present invention includes providing cross-enterprise portals having consistent operating environments to support the distribution of components through e-commerce supply chains. The components may be encapsulated components developed for internal use, published by other companies within the supply chain, or purchased from third party portal and e-commerce vendors. The use of the term “Supply Chain” in this context is not limited to the distribution of hardware or materials and may also include the distribution of other intellectual properties.

The present invention provides at least one distributed component operably associated with establishing a cross-enterprise portal between a first portal and a second portal. One or more components may be stored within a storage operably associated with either portal wherein each components may include software or hardware modules encoded to assist with providing an interface for securely communicating information. One or more components may be associated with a cross-enterprise environment and may include, but are not limited to, director components, supplier components, legacy front-end components, and agent components.

According to one aspect of the invention, one or more components may be encapsulated, distributed, and employed to provide a cross-enterprise environment. An encapsulated component may include a group of system resources enclosed within a local firewall. The system resources within an encapsulated component could include a file system, databases, applications, software components, virtual memory, administrative interfaces, user interfaces and application programming interfaces (API's). The local firewall may prevent unauthorized processes (or threads) outside of the component from accessing the enclosed system resources while allowing processes (or threads) within the component to use the enclosed system resources as needed. External processes would only be allowed to use the resources within an encapsulated component by connecting to specific services that were “exported” by the component. By standardizing the sets of services that are exported by encapsulated components, large application systems may be built up by plugging groups of encapsulated components into “virtual motherboards”. Cross-enterprise portals are essentially virtual motherboards that support the replication and integration of encapsulated components.

In one embodiment, developers of large web sites could use cross-enterprise portals to distribute routine processing tasks and reduce network congestion. Additionally, suppliers or vendors could use cross-enterprise portals employing encapsulated components to distribute customized catalogs to their customers and to integrate the customized catalogs into their customer's purchasing systems. These components could include the supplier's entire catalog in a local database or just an index with links to a back-end database.

Distributors of licensed products (logo's, animated characters, etc.) could use cross-enterprise portals employing encapsulated components to distribute sales information through varied distribution channels. Such sales information could include product specifications, promotions, ordering instructions, photos, and advertisements (still images or videos). Such encapsulated components could also support the integration of the distribution channel's purchasing process with a purchaser or third party distribution process.

Due to limitations of current operating systems, initial implementations of the cross-enterprise portals may offer limited encapsulation (protection) for published components may be initially limited to trusted trading partners. Since a trust relationship will already exist between each of the partners, there will be less need for encapsulation of each component.

Operating systems using cross-enterprise portals having encapsulated components will be more resistant to virus and hacker attacks then existing operating systems. Since current operating systems generally do not encapsulate components there is little they can do to control the damage done by a hacker or virus once access has been gained to a system.

In a system using encapsulated components, a virus or a hacker could gain access to a component by finding the same sorts of security flaws that allow them to access existing systems. However, breaching the system's external security measures would only give them access to a single component. The firewalls maintained between the encapsulated components would substantially limit the extent of the security breach. For example, a virus or hacker that gained access to one component would not preferably have access to files associated with other components.

FIG. 1 illustrates a system for providing a cross-enterprise portal according to one embodiment of the present invention. A network system, illustrated generally at 100, includes a cross-enterprise portal 101 operably associated with an intersection between a company's intranet 105 and the Internet 106. Cross-enterprise portal 101 may be configured to include one or more components such as Supplier A Component 102, Supplier B Component 103, and/or Supplier C Component 104. Each component may be installed and/or published within cross enterprise portal 101 by each supplier. For example, Supplier A may use Supplier A secure channel 110, Supplier B may use Supplier B secure channel 111, and Supplier C may use Supplier C secure channel 112. Each supplier component 102, 103, 104 may establish a secure communication channel to an associated publisher's backend system using Supplier A Secure Channel 110, Supplier B Secure Channel 111, and Supplier C Secure Channel 112.

One or more users/buyers may be connected to cross-enterprise portal 101 components through a web-based interface (using a web browser). As illustrated, first Buyer 107 may be connected to Supplier A component 102 and Supplier B component 103. Similarly, second Buyer 108 may be connected to Supplier A component 102 and Supplier C component 104. Additionally, third Buyer 109 may be connected to Supplier B component 103 and Supplier C component 104. In this manner, end users or buyers may have the option to connect only to those components that add-value to their individual work assignments. While this illustration shows a one-to-one relationship between suppliers (publishers) and components, no such relationship is intended as a general rule. A single supplier could publish multiple components related to different products or business activities.

For example, Supplier A component 102 and Supplier C component 104 may each include customized catalogs for each supplier's respective products. Likewise, Supplier B component 103 could provide a link to a collaborative workgroup environment being used by several vendors cooperating to design a new product. For example, first buyer 107 and third buyer 109 may examine product specifications and pricing as part of the design process. Additionally, second Buyer 108 may use a workstation based “agent” (not expressly shown) to compare prices for commodities sold by both Suppliers A and C. The agent may use standard interfaces (queries or transactions) to combine product information provided by Supplier A and Supplier C.

As such, the architecture of cross-enterprise portal 100 move the cost of developing secure Internet interfaces from the buyer back to the supplier. Additionally, suppliers can spread the cost of developing these interfaces across many buyers or users. Further, each supplier can offer its buyers a higher level of customer service by gaining more direct access to the buyer's internal network.

In one embodiment, network system 100 may employ encapsulated components having a standard operating environment and standard external interfaces (methods, transactions, and queries), offer a web based user interface (HTML, etc.), and be secure from intrusion from un-authorized access. The standard operating environment (not expressly shown) may include web hosting services (http, ftp, active components, scripts, etc.), database support (SQL Server, etc.), and middleware services (CORBA, DCOM, etc.). Regardless of where a component physically resides, a supplier or publisher may retain ownership and control of the encapsulated component creating a trusted extension of the publisher's internal information system.

In one embodiment, network system 100 may include a wireless network as Intranet 105 and/or Internet 106 and may include using one or more wireless protocols (such as WAP) to enable communication using cross-enterprise portal 101 having one or more supplier components 102, 103, 104. As such, a first portal may include a wireless portal and a second portal may include a wireline portal for communicating information between Intranet 105 and Internet 106.

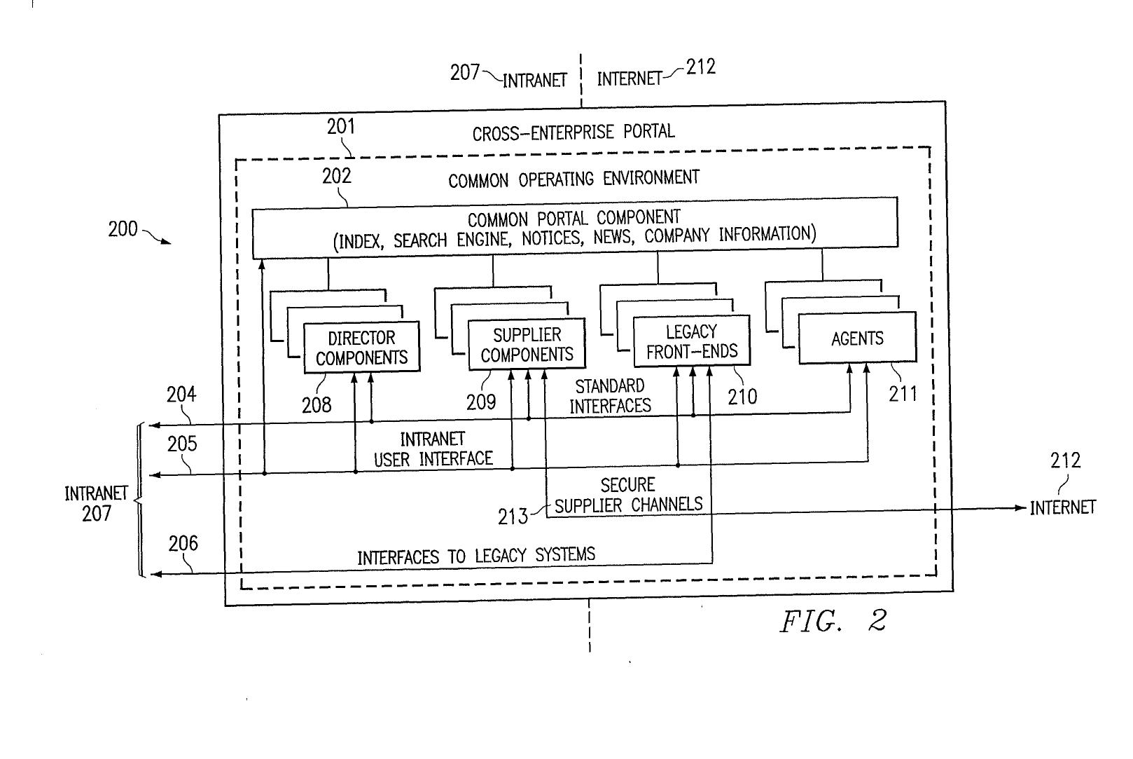

FIG. 2 is an illustration of a cross-enterprise portal according to one embodiment of the present invention. A cross-enterprise portal, illustrated generally at 200, communicates with an Intranet 207 and the Internet 212 using Common Operating Environment 201. Common operating environment 201 facilitates multiple publishers (suppliers) to publish components to cross-enterprise portal 201 using minimal amounts of administrative overhead. Cross-enterprise portal 201 includes a common operating environment 201 and a common portal component 202 communicatively coupling one or more components to provide a common interface for one or more users.

In the embodiment illustrated in FIG. 2, Cross-enterprise portal 200 may support four basic types of encapsulated components. For example, Director components 208 manage the flow of information between other information systems (including other portal components) and may be purchased from portal and e-commerce software vendors. Supplier components 201a automate a business process that crosses a business boundary and may be distributed along a supply chain by suppliers. Agents 211 may be developed for internal use or purchased from a third party software vendor. Agents 211 may use e-commerce interfaces supported by other components (and external systems) to consolidate (aggregate) information for a specific use. Legacy Front-Ends 210 may be developed for internal use and can map legacy information systems into the component model supported by cross-enterprise portal 200.

For example, a cross enterprise portal 200 could include a single director component 208 that would manage the purchasing process for a warehouse by integrating with standard interfaces exported by a set of supplier components 209. Each supplier component may be provided by the supplier of a single stock item or a related group of stock items. Supplier components may communicate with each supplier's back office systems through encapsulated secure supplier channels 213 to check on product availability, obtain price quotes, process orders and check on order status. Agents 211 could be used to consolidate and compare prices quoted by multiple supplier components while legacy front-ends 210 could define the standard interfaces required to support the integration of the company's financial systems into the purchasing process.

Common portal component 202 may be coupled to director components 208, supplier components 209, legacy front-ends 210, and/or agents 211. Intranet 207 may provide access to one or more components using an associated interface. For example, a standard interface 204 may be used to provide access to director components 208, supplier components 209, legacy front-ends 210 and agent 211. Likewise, an Intranet user interface 205 may be used to access one or more components coupled to common portal component 202. Interfaces to legacy systems 206 may be coupled to legacy front-ends 210 associated with common portal components 202. One or more secure supplier channels 212 may be used to provide a supplier access to supplier components 209 via Internet 212 to publish, update, provide, manage, delete, etc. supplier components 209.

Common portal components 202 may be accessible to both administrators and end users through a web based user interface (not expressly shown). Authorized administrators will be able to use this interface to manage security for the cross-enterprise portal 200 including the administration of component interfaces 204, 205, 206. End users may use common portal component 202 to search for other portal components and to access general news. For example, a news item could be posted to common portal component 202 each time a new service (component) is installed.

In one embodiment, each component 208, 209, 210 and 211 may interact through standard interfaces (transactions or queries). For example, each component may provide end users with intranet user interface 205 (accessible through a standard web browser). Additionally, each interface 204, 205, 206 may be used by authorized administrators to set configuration options for components 208, 209, 210 and 211 and by end users to access services offered by components 208, 209, 210 and 211. As illustrated, supplier components 209 may be used to establish secure connections to the appropriate backend systems using secure supplier channels via Internet 212. Legacy front-end components 210 may establish connections to legacy systems through an associated intranet 207.

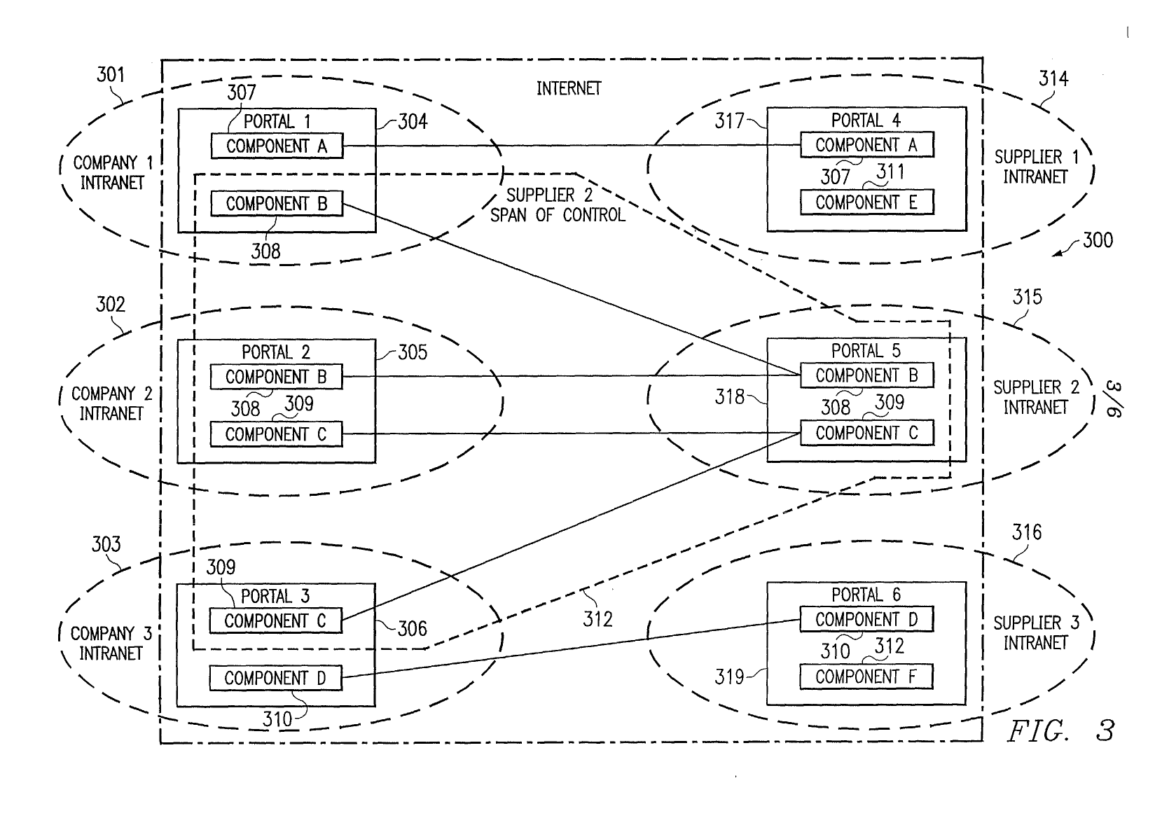

FIG. 3 is an illustration of a system and method for portal to portal distributing components among suppliers and users according to one embodiment of the present invention. Illustrated is a network 300 of companies and suppliers that have exchanged portal components to build an integrated business-to-business information system. While a clear distinction between companies (buyers) and suppliers is illustrated in FIG. 3, no such distinction is intended as a general rule. For example, one company may be a supplier to another company with respect to one product or service, and a buyer with respect to another product or service.

Network system 300 includes a first company intranet 301 including a first portal 304 having component A 307 and component B 308. Second company intranet 302 includes a second portal 305 having associated component B308 and component C 309. Likewise, third company intranet 303 includes a third portal 306 having associated component C 309 and component D 310.

First supplier intranet 314 includes fourth portal 317 having associated component A 307 and component E 311. Second supplier intranet 315 includes fifth portal 318 having associated component B 308 and component C 309. Likewise, third supplier 316 includes sixth port 319 having associated component D 310 and component E 312.

Each portal may be realized as a cross-enterprise portal communicating components from a first Intranet to a second Intranet via the Internet. One example of a cross-enterprise portal is graphically illustrated as second supplier span of control 312 indicating associated distributed components such as component B 308 and component C 309. As such, each supplier includes a span of control which includes components and associated cross-enterprise portals.

FIG. 3 illustrates portals comprised of components from multiple suppliers and multiple components from a single supplier. For example, first portal 301 includes components distributed from fourth portal 317 and fifth portal 318 while second portal 305 includes two components distributed from fifth portal 318. As such, several combinations of components may be published by one or more suppliers to produce a desired portal for a user. Suppliers may independently manage the secure delivery of information to the local portals operated by their customers. Companies that implement cross-enterprise portals can implement complex business-to-business processes by connecting together supplier components within a single portal using standard interfaces.

In one embodiment, each component (not expressly shown) includes a globally unique identifier allowing each component to retain identification independent of where the component is installed. For example, the same component can be on multiple portals and can provide the same globally unique identifier for each portal. The use of globally unique identifiers can substantially reduce the need for central administration of distributed components.

In one embodiment, globally unique identifiers may be operable to provide dedicated workspace (virtual) on plural portals for a specified component. A secure protocol for the distribution of components from one portal to another allows for the dedicated workspaces to be populated with instances of the associated components. Each component may be separately encapsulated based on its globally unique identifier thereby allowing the addition of a new component without causing addressing or resource conflicts within a portal. In one embodiment, in a new component's initial state, its firewall could be closed down. A portal administrator could then selectively open the firewall after the completion of appropriate security checks.

While suppliers or publishers may retain control over the content of the components that they publish, suppliers or publishers may allow an administrator (or even an end user) of a company's Intranet to modify the behavior of a component through an administrative user interface (not expressly shown). Administrators may also be able to manage the external interfaces between components by locking out all interfaces, by allowing only specific interfaces, or by allowing all interfaces. Administrative and end user access privileges may be administered separately for each portal and may not require any intervention by the various suppliers or publishers of the components. As such, a company that installs a cross-enterprise portal can enable interfaces between components through an administrative interface simplifying development of new agents for all of the interfaces included within a single standardized operating environment. Additionally, component publishers can manage the transmission of information across the Internet using the standard services supported by an associated portal. As such, companies will not have to deal with all of the administrative, security and technical issues associated with complex multi-vendor Internet interfaces.

By providing a secure and cost effective protocol for the distribution of components, the cross-enterprise portal allows integration of large numbers of simple components. In the manner, a finer level of component granularity enhances the cross-enterprise portal leading to a higher level of customer service and more effective integration of components across business boundaries.

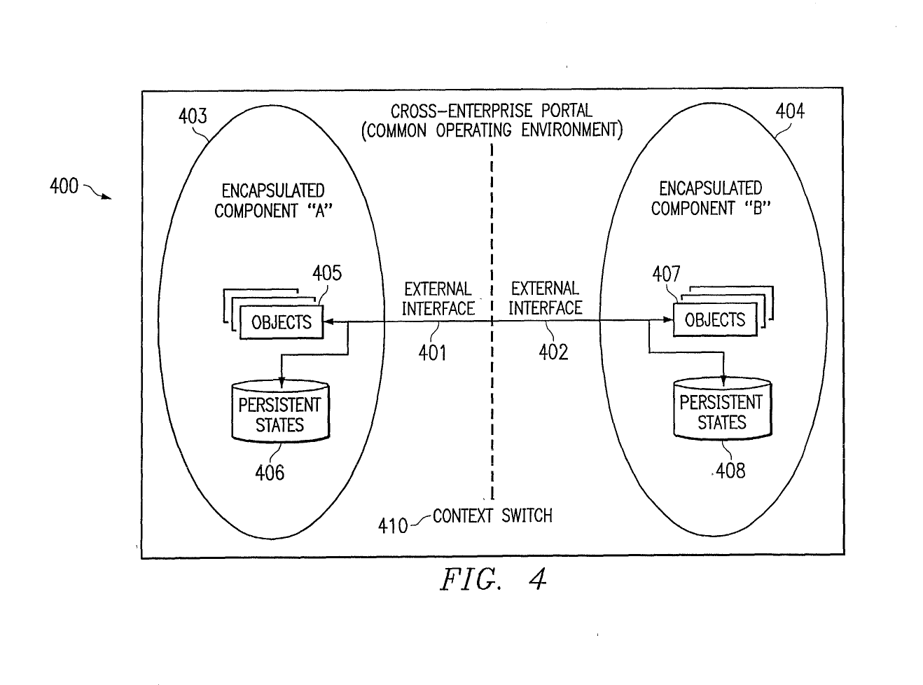

FIG. 4 illustrates interaction between external interfaces of components of a cross-enterprise portal according to one embodiment of the present invention. A cross-enterprise portal, illustrated generally at 400, includes a common operating environment for distributed components. Cross-enterprise portal 400 includes an encapsulated component A 403 having associated objects 405 and persistent states 406. Encapsulated component A 403 communicates with encapsulated component B via first external interface 401 and second external interface 402. A context switch 410 may be provided to limit access between each external interface 401 and 402. Encapsulated component B 404 includes associated objects 407 and persistent states 408.

During use, objects 405 and 407 may interact through external interfaces 401 and 402 operable to enable access across boundaries of encapsulated components A 403 and B 404. Each object may present an external interface (not expressly shown) to cross-enterprise portal 400 (operating system). In one embodiment, objects 405 and 407 can be defined either within a “Common Operating Environment” of cross-enterprise portal 400 or within the encapsulated component itself. In either case, once an encapsulated component has been initialized, the component can operate within the context of a single component. Additionally, various levels of complex objects defined by the common operating environment may be realized by cross-enterprise portal 400. In a preferred embodiment, objects operable with a common operating environment are accessible by a portal such that encapsulated components can be reliably distributed.

In one embodiment, a portal administrator would have the option of fully enabling an external interface, enabling an external interface with restrictions, or disabling an external interface. For example, enabling external interfaces 401 and 402 establishes a connection between each component 403 and 404 as illustrated. Also, as control passes across external interface 401 and 402, context switch 410 would be enabled as control is passed between an encapsulated component A 403 and encapsulated component B 404.

In another embodiment, objects initialized within the context of encapsulated component A 403 would operate within the context of that component and may not have direct access to resources encapsulated within encapsulated component B 404. Likewise, objects instantiated within the context of encapsulated component B 404 would operate within the context of that component and may not have direct access to the resources encapsulated within encapsulated component A 403.

In one embodiment, external interface 401 or 402 could allow objects 405 and 407 to store persistent states 406 and 408 across component boundaries. For example, encapsulated component A 403 or B 404 may include a compound document having persistent state information saved by objects initiated in another component. This would not violate the integrity of encapsulated components A 403 or B 404 as long as the persistent state information were not used to initialize new objects in the context of different components. In one embodiment, the structure of existing compound documents could be extended to store component context information along with other state information. Additionally, object oriented databases could also be modified to store component state information. By storing component state information with other state information, an operating system could set the correct component context for context switch 410 during object initialization.

In one embodiment, encapsulation may be used in association with a cross-enterprise portal allowing components to be distributed from many sources throughout a supply chain (some trusted and some suspect). Encapsulation advantageously reduces instability effects caused by errant components having free access to a portal. Encapsulation allows a portal administrator to map each component's external interface into an integrated e-commerce system.

An encapsulated component may be operable inside an internal firewall. In one embodiment, the system resources required by the component may be included within the firewall such as files, databases, executable modules, configuration data, and back-end connections (Open Database Connectivity (“ODBC”) links, middleware, etc.). The component may use these resources freely and can be isolated from using resources associated with other components unless authorized by the other component's publisher. These internal firewalls improve the stability of the cross-enterprise portal by minimizing unwanted component interaction.

Each encapsulated component can present a standard external interface through the firewall. The portal administrator may enable or disable an external interface in whole or in part. The publisher of each component may have freedom to change the internal operation of an encapsulated component so long as its external interface remains stable. Note that a stable interface can be extended as long as the original interface is still supported.

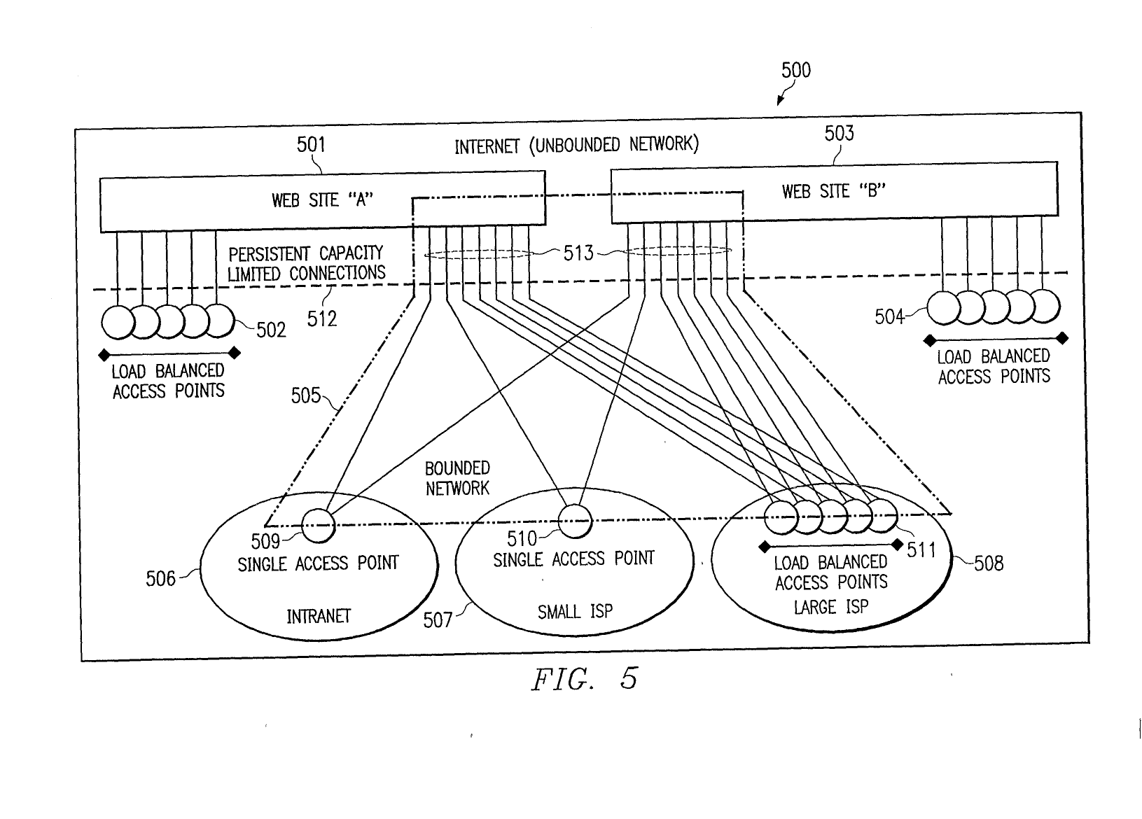

FIG. 5 illustrates a network system utilizing distributed access locations according to one embodiment of the present invention. A network system, illustrated generally at 500, includes a collection of distributed access points that may be used to consolidate traffic for a number of web sites. Network system 500 includes website A 501 having associated load balanced access points 502 and website B 503 having associated load balanced access points 504. Each website may be coupled via an unbounded network and/or may be coupled to Intranet 506 including a single access point 509, a small ISP 507 including an associated single access point 510, and/or a large ISP including associated load balanced access points 511. In one embodiment, a bounded network 505 may be used to provide access to websi.te 501 and/or website B 503.

For example, a set of distributed access points 513 may be established for Web Site A 501 and Web Site B 503. Additionally, load-balanced access points 502 and 504 may be implemented within the Internet (public network) for both sites providing public access points to support traffic not otherwise consolidated by the distributed access points within bounded network 505.

Network system 500 includes distributed access points for intranet 506, Small ISP 507 and Large ISP 508. However, a large ISP such as large ISP 508 may install multiple access points and use load balancing to route local traffic through the access points. In one embodiment, all of the connections to the web sites would be persistent and capacity limited (either static, dynamic or adaptive) as illustrated at 512.

In one embodiment, access points 513 may consolidate traffic for a subset of servers within bounded network 505. A specific subset selected for an access point may be determined based on the requirements of a workstation (end users) served by the access point.

Network system 500 advantageously provides both bounded and unbounded networks with distributed access for accessing Web Sites. Most existing Internet sites only provide one entry point for their customers. Multiple servers are often implemented to support peak workloads but load balancing is used to spread the traffic across the various servers. A single denial of service attack can flood all of the servers simultaneously and effectively block legitimate or desired traffic. The Internet is designed to provide end users with universal access to a virtually unlimited collection of web sites. This principle of universal access provides no protection against denial of service attacks launched from servers distributed in arbitrary patterns.

Because Internet routers (and other Internet equipment) must process huge numbers of packets destined for an equally huge number of web sites, there are practical limits on the amount of analysis and filtering that may be done by an individual router relative to the traffic destined for any specific web site. Current strategies for resisting denial of service attacks involve tracing the source of the attack and then blocking all packets originating from that source. While the responsibility for tracing attacks generally falls on the operator of the web site that is being attacked, web site operators have neither the resources to trace attacks nor the level of control required to block attacks near the source(s).

Network system 500 illustrates one embodiment of the present invention that provides for bounded networks (possibly built using private virtual networks), such as bounded network 505, to be built within the context of an unbounded network, such as the Internet. In this context, a “bounded network” may be operable as a network the includes a limited number of servers (or web sites) and end users while an “unbounded network” may be operable as a network (such as the Internet) that includes an unlimited number of servers and end users. As such, the bounded network 505 connects a limited number of web sites with a large number of independent subnets within the unbounded network to properly formatted and otherwise legitimate traffic, and use limitors to balance the traffic associated with specific web sites.

Separate access points 513 may be installed within each subnet or bounded network 505. Access to bounded network 505 may be restricted to valid packets destined for selected web sites 501 and/or 503. Since the number of web sites supported by bounded network 505 will be limited, access points 513 will be able to analyze and filter packets to a much greater extent then traditional Internet routers. For example, specific packet profiles may be loaded for each web site 501 and 503 into the access points 513 allowing access points 513 to be expert systems loaded with general and site-specific rules. Web site 501 and 503 operators may extend the rules for their site as new security exposures are identified.

Since it would be difficult for a single computer or individual to gain access to any significant number of these independent subnets, it would be extremely difficult for a hacker to mount a comprehensive denial of service attack against such distributed access points 513. While access point 513 within an individual subnet or bounded network 505 could be attacked, the source of the attack would be much easier to isolate (since the source would be within the subnet). Also, since the failure of an individual access point would affect a single subnet or bounded network 505, the burden of isolating and blocking attacks would shift from web site 501 and/or 503 being attacked to operators (companies and ISP's) of the subnets hosting the attack such as Intranet 506, small ISP 507 and/or large ISP 508.

In a further embodiment, improved security for network system 500 includes providing web sites 501 and 503 and subnets connected to bounded network 505 with specific security standards. For example, ISP 507 could be required to partition their web hosting facilities from bounded network 505 or implement specific security policies to make sure that the servers in their web hosting facility could not be used to mount a denial of service attack against bounded network 505. ISP 507 may also be required to exclude academic sites and business without properly configured firewalls from bounded network 505.

In one embodiment, a network component (“distributed access point”) associated with network system 500 may consolidate traffic for multiple web sites onto one or more bounded network 505. Traffic bound for selected web sites can be redirected within an intranet or ISP subnet and passed to distributed access points such as site 513. Since traffic bound for the selected sites can be redirected automatically, the use of the distributed access points is operable to be transparent to end-users. Because the access points may only be required to process packets for a limited number of web sites, the access points can act as firewalls and filter out invalid packets (improper formats, unsupported network protocols, invalid TCP/IP ports, etc.).

Network system 500 may also include access points 513 as distributed access points may be capacity limited so that a single access point may not overload the selected web sites. Capacity limits could be static, dynamic or adaptive. In one embodiment, when utilizing a static capacity limit, once the fixed capacity of a static connection is reached the performance of the associated access point would degrade. In another embodiment, the capacity of dynamic access points may vary based on the total load on the selected web sites. For example, if web site 501 was lightly loaded, access points 513 operable a dynamic connections could operate as if they had unlimited capacity. As the load on web site 501 increases, the limits on the dynamic connections may be reduced. This process would fairly allocate capacity across access points 513 and allow performance to degrade consistently for the most heavily utilized access points. In yet another embodiment, access points 513 may be operable as adaptive access points that can learn to recognize normal and abnormal traffic patterns for individual web sites and would set traffic limits based on the detection of abnormal traffic patterns.

In one embodiment, access points 513 operable as distributed access points could be designed as standalone network devices, as components of other network devices (routers, firewalls, etc.), or as portals. In addition to aggregating traffic, portals (not expressly shown) could be used to distribute components of the selected web sites into protected subnets or bounded networks. The distribution of services in this manner could help to reduce network congestion by minimizing the amount of routine traffic passed from the protected subnets to the selected web sites. The portals could represent an additional revenue opportunity for ISPS, as they could be used to integrate local content (advertising, news, etc.) into the web pages associated with the selected web sites.

In another embodiment, a portal designed to support encapsulated components could serve as an access point operable as a distributed access point for a large number of central sites. The web site developers would control the content of their encapsulated components and the portal would protect the integrity of these components. Standard interfaces could be designed to allow for the integration of local content with the encapsulated web site components.

Using this business model, the cost of establishing access point 513 for any individual company would be minimal. The distributed access points could be implemented in very large numbers thereby making large-scale denial of service attacks against selected web sites difficult to achieve.

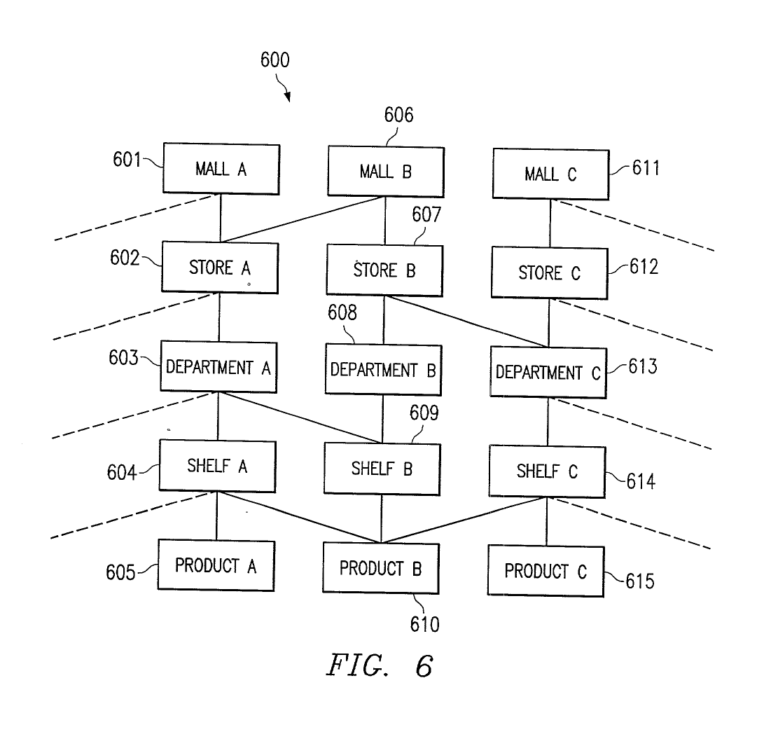

FIG. 6 illustrates an exemplary retail mall deploying cross-enterprise portal components according to one embodiment of the present invention. One or more retail malls 601, 606, 611 may be deployed using a cross-enterprise portal and may include a layered set of encapsulated components. Retail malls 601, 606 and 611 may be developed and managed for specific web sites and may include several layered components.

A store component, such as store A 602, may include one or more departments 603, 608 and/or 613 associated with a specific retailer. Stores, departments and shelves may be developed and managed by specific retailers. Additionally, department components 603, 608 and 613 may include a collection of shelves 604, 609 and/or 614 associated with a special interest group (or affinity group). Shelf components 604, 609 and 614 may include a collection of similar products 605, 610 and 615 including different styles and brand names. Product components 605, 610 and 615 may include detailed information related to a specific product and/or a group of closely related products. Product components 605, 610 and 615 may be developed and managed by retailers, distributors or manufacturers.

Retail mall 601, 606 and/or 611 may include a collection of “stores” and “aggregators” associated with a specific distribution channel or channels. For example, an aggregator component (not expressly shown) may be associated with mall B606 and may include a collection of stores that offer similar products and/or services. Aggregator components may implement marketplaces for specific product categories. Retail Mall 600 may include utilities components (not expressly shown) having common services that may be used by other components of a retail mall 601, 606 and 611 such as session management, shopping cart management, credit card authorization, map generation, and advertising. Utilities components may be developed and distributed by software vendors and systems integrators.

As illustrated in FIG. 6, several components such as malls, stores, departments, shelves and products may used and/or re-used in multiple contexts to provide a retail mall deploying cross-enterprise portal components. For example, Store A component 602 may be included in both Mall A component 601 and Mall B component 606. Department C component 613 may be included in both Store B component 607 and Store C component 612. Shelf B component 609 may be included in both Department A component 603 and Department B component 608. Product B component 610 may be included in Shelf A component 604, Shelf B component 609 and Shelf C component 615. During use, session parameters may be maintained for each user. As such, a single logical mall may be presented for each user based on session parameters for the user regardless of how many different ways each individual component of a mall was being re-used.

In another embodiment, layered components may be designed such that they may be re-used in many different contexts. For example, a retail distributor could build store A 602 to support a dedicated Internet website. As such, store A 602 may include a set of departments 603, 608, 613, etc., with each department including a set of shelves 604, 609, 614, etc., and each shelf including a set of products 605, 610, 615, etc.

In addition to a dedicated Internet web site, a retail distributor may sell products through one or more Internet Malls. For example, store component B608 may be developed for the retailer's dedicated Internet site deploying Mall A 601 and may not be appropriate for use within Mall B 606 or Mall C 611. However, store B's 608 associated department, shelf and product components may be appropriate for such Internet Malls as Mall A 601 and Mall C 611 and re-used as needed. For example, while product B 610 may appear on multiple shelves 604 and 614, each shelf may reference the same product component. As such, changes for a single product may be distributed for that single product component and may be automatically reflected in all of the associated shelves. In a similar manner, changes distributed for a single shelf may be automatically reflected within associated departments, and changes distributed for a single department may be automatically reflected within associated stores.

In another embodiment, it may not be necessary to implement all of the layers implemented for every retailer. For example, a retailer that offers a single product (or a very limited product range) may encapsulate all of their products and services within a single store component such as store C component 612. In other embodiments, a slightly more complex retailer may implement just store and product components. For example, an express mail provider (United Postal Service, Federal Express, etc.) may encapsulate all of their products and services within a single store component.

In one embodiment, a set of standard application programming interfaces (API's) may be defined for each layer of a Retail Mall. In many cases, these interfaces may be replicated for each component layer. For example, a consumer accessing Mall B 606 may enter a search for a store in a particular zip code with a particular product in stock. Mall B 606's component may then query each of its associated Stores such as Store A 602 in Mall A 601. Additionally, stores may then query each of their associated departments, and each department may then query an associated shelf. In one embodiment, inventory levels may be managed at the “Shelf” level minimizing a need to pass a query to the “Product” layer to determine a product's availability. Product components may provide detailed product information independent of the product's location or availability.

In another embodiment, components for a retail mall may also be designed to adapt their behavior based on specific session parameters. For example, session parameters may be saved in a common Internet “cookie” or other form of persistent storage and could be administered by a session management component (utility component). As such, this type of dynamic adaptation may include the ability to customize output based on each user's preferred geographic region such as the Internet, zip codes, cities, counties, states, or countries. In this manner, a user may search the “Mall” either for products available through the Internet or through stores in a designated geographic region.

In one embodiment, session parameters saved for each user may include a record of the mall, store, department, shelf, product and last components visited by each user. Such parameters may be used by the components to assist users a they navigate through a mall. For example, while a single store may be included in more then one mall, session parameters may be used to ensure a user may be returned to the appropriate mall when a “home” button is selected.

Although the disclosed embodiments have been described in detail, it should be understood that various changes, substitutions and alterations can be made to the embodiments without departing from their spirit and scope.

What is claimed is:

1. A cross-enterprise system comprising:
a first portal operably associated with a distributed component stored within a storage medium accessible by a second port; and
a cross-enterprise environment established between the first portal and at least the second portal using the distributed component.

2. The system as recited in claim 1 further comprising the distributed component distributed from at least one supply chain.

3. The system as recited in claim 1 further comprising a global identifier associated with the distributed component and the first and second portal.

4. The system as recited in claim 1 further comprising a dedicated workspace associated with the distributed component.

5. The system as recited in claim 1 further comprising distributed access locations.

6. A method of providing a portal to portal environment, comprising:
providing a component associated with a supplier portal; and
distributing the component to a user portal, the component operable to provide an association between the supplier portal and the user portal.

7. The method of claim 6 wherein the component comprises distributing an encapsulated component.

8. The method of claim 6 further comprising a global identifier associated with the component.

9. The method of claim 6 further comprising distributing the component to plural user portals.

10. The method of claim 6 further comprising distributing the component from the user portal to a second user portal.

11. The method of claim 6 further comprising identifying a workspace associated with the component.

12. A distributed portal to portal system comprising:
at least one supplier portal operable to provide communication between a plurality of networks;
at least one encapsulated component operably associated with the at least one supplier portal; and
at least one user portal, operable to receive a plurality of distributed encapsulated components.

13. The system as recited in claim 12 wherein the plurality of distributed encapsulated components include a global identifier operable to globally identify the distributed component.

14. The system as recited in claim 12 further comprising a retail mall environment operably associated with the at least one supplier portal.

15. The system as recited in claim 12 further comprising a business to business cross enterprise environment associated with the at least one supplier portal and the at least one user portal.

16. The system as recited in claim 12 further comprising a legacy front end component operable to provide access between a legacy system and the at least one supplier portal.

17. The system as recited in claim 12 wherein the at least one user portal comprises the at least one supplier portal.

18. A secure network system comprising:
an unbounded network operable to serve a plurality of servers and end users;
a bounded network comprised within the unbounded network, the bounded network operable to serve a limited number of servers and end users;
a plurality of distributed access points operable to divert network traffic associated with the servers within the bounded network from the unbounded network; and
each access point operable to intercept network traffic originating from a distinct group of workstations.

19. The system as recited in claim 18 further comprising each access point operable to consolidate traffic for a subset of servers within the bounded network.

20. The system as recited in claim 19 wherein the access points comprise network devices.

21. The system as recited in claim 19 wherein the access points comprise portals.

22. The system as recited in claim 19 wherein the access points comprise filters operable to limit network traffic to properly formatted and otherwise legitimate traffic associated with the servers within the bounded network.

23. The system as recited in claim 18 wherein the access points comprise network devices.

24. The system as recited in claim 18 wherein the access points comprise portals.

25. The system as recited in claim 18 wherein the access points comprise filters operable to limit network traffic to properly formatted and otherwise legitimate traffic associated with the servers within the bounded network.

26. The system as recited in claim 25 wherein the access points comprise capacity limitors operable to balance the traffic associated with specific servers within the bounded network.

27. The system as recited in claim 26 wherein the capacity limitor comprises a static limitor.

28. The system as recited in claim 26 wherein the capacity limitor comprises a dynamic limitor.

29. The system as recited in claim 26 wherein the capacity limitor comprises a adaptive limitor.

30. A cross-enterprise system for retail environments comprising:
at least one component stored within a storage medium; and
a plurality of distributed components operably associated with a cross-enterprise portal, the cross-enterprise portal including the retail environment.

31. The system as recited in claim 30 wherein at least one of the distributed components comprises a utility component operable associated with a common service.

32. The system as recited in claim 30 wherein at least one of the distributed components comprises a store component operable associated with a retailer.

33. The system as recited in claim 30 wherein at least one of the distributed components comprises a department component.

34. The system as recited in claim 30 wherein at least one of the distributed components comprises an aggregator component operable associated with at least one store component.

35. The system as recited in claim 30 wherein at least one of the distributed components comprises a shelf component operable to identify similar products.

36. The system as recited in claim 30 wherein at least one of the distributed components comprises a product component operably associated with at least one retailer, the product component operably associated with a group of products.

37. A method for providing a retail mall using a distributed components comprising:
providing at least one component operable associated with a mall; and
associating a distributed component with the component, the distributed component operable to be used in association with a user accessing the retail mall.

38. The method of claim 37 further comprising providing a session management component associated with the user accessing the retail mall.

39. The method of claim 37 further comprising providing a plurality of component layers operably associated with a plurality of retailers.

40. The method of claim 39 further comprising providing a product component operably associated with one of the components layers.

41. The method of claim 37 further comprising a providing a plurality of malls.

42. The method of claim 37 further comprising reusing at least one the distributed components associated with the mall.
